(19) United States
(12) Patent Application Publication
(10) Pub. No.: US 2007/0285460 A1
(43) Pub. Date: Dec. 13, 2007

(54) Method and device for cleaning ink cartridges

(76) Inventors: Al Leslie Beatham, Glen Marais (ZA); David John Hoggan, Ulakfontein (ZA)

Correspondence Address: LADAS & PARRY LLP, 224 SOUTH MICHIGAN AVENUE, SUITE 1600, CHICAGO, IL, 60604, US

(21) Appl. No.: 11/489,179

(22) Filed: Jul. 19, 2006

(30) Foreign Application Priority Data
Jun. 9, 2006 (ZA) 2006/04756

(51) Int. Cl. B41J 2/165

(52) U.S. Cl. 347/30

(57) ABSTRACT

The invention concerns a method for cleaning an ink cartridge. The method includes the steps of: introducing a cleaning fluid into an ink cartridge to be cleaned and drawing the cleaning fluid out of the ink cartridge through a nozzle of the cartridge by vacuum pressure.

### BACKGROUND OF THF INVENTION

THIS invention relates to ink cartridges, and more specifically to ink cartridges for printers. In particular, the invention relates to a device for cleaning cartridges such as laser or ink-jet cartridges for printers prior to the refilling or the remanufacturing of the cartridges. The invention also relates to a method for cleaning such cartridges.

Generally, prior to the refilling or the remanufacturing of ink cartridges, it is necessary to remove residual ink from the cartridges. In known methods, the cartridges are cleaned by introducing water into the cartridges, and allowing the water and residual ink to drain from the cartridges.

A problem with these cleaning methods is that the flow of water alone often does not result in effective and efficient cleaning.

It is an object of the present invention to provide a method and a device for cleaning ink cartridges in an effective and efficient manner.

### SUMMARY OF THE INVENTION

According to a first aspect of the invention there is provided a method for cleaning an ink cartridge, the method including the steps of:
introducing a cleaning fluid into an ink cartridge to be cleaned; and
drawing the cleaning fluid out of the ink cartridge through a nozzle of the cartridge by vacuum pressure.

The cleaning fluid may comprise water, and the method may include the step of introducing the water into the ink cartridge through one or more needles.

Preferably, the water is allowed to gravity feed into the ink cartridge through a plurality of needles.

The method may include the step of inserting the needles into the ink cartridge through ink filling apertures in the cartridge.

Typically, the flow of cleaning fluid into the ink cartridge is controlled by at least one valve such as, for example, a solenoid valve.

The step of drawing the cleaning fluid out of the ink cartridge may include the steps of:

forming a vacuum in a vacuum chamber; and

providing fluid communication between the ink cartridge and the vacuum chamber so as to apply vacuum pressure to the ink cartridge.

The method may also include the step of controlling the vacuum pressure applied to the ink cartridge. For example, the vacuum pressure applied to the ink cartridge may be maintained between 10 inches Hg (34 kPa) and 15 inches Hg (51 kPa).

In one arrangement, the method includes the step of cleaning a plurality of ink cartridges simultaneously.

Typically, at least some of the method steps are carried out automatically by means of a programmable logic controller (PLC). For example, the method may include the steps of automatically controlling the insertion of needles into a plurality of ink cartridges to be cleaned, automatically controlling the flow of water into the ink cartridges, automatically controlling a vacuum pressure applied to the ink cartridges, and automatically controlling the withdrawal of the needles from the ink cartridges.

Alternatively, at least some of the method steps my be carried out automatically by using pneumatic switches, pneumatic control valves and pneumatic timers.

According to a second aspect of the invention there is provided a device for cleaning an ink cartridge, the device including:
a mechanism for introducing a cleaning fluid into an ink cartridge to be cleaned;
a vacuum chamber;
means for forming a vacuum pressure within the vacuum chamber; and
a connector for operatively allowing fluid communication between the vacuum chamber and the ink cartridge for drawing the cleaning fluid out of the cartridge through a nozzle of the cartridge by vacuum pressure.

In one embodiment, the mechanism for introducing the cleaning fluid into the ink cartridge comprises one or more, preferably three, needles which may be mounted to a needle holder.

The cleaning fluid may be water, in which case the needles may be connectable to a water tank.

Typically, the device includes at least one valve, for example a solenoid valve, for controlling the flow of water from the water tank into the ink cartridge.

The device may also include a cartridge holder for holding one or more ink cartridges.

Preferably, the cartridge holder is arranged to hold a plurality of ink cartridges, and the needle holder is movable relative to the cartridge holder between a first position in which the needles are withdrawn from the ink cartridges, and a second position in which the needles are inserted into the ink cartridges, for example through ink filling apertures in the cartridges.

In one embodiment of the invention, the means for forming a vacuum within the vacuum chamber comprises a vacuum pump, and the device includes at least one valve, for example a solenoid valve, for controlling the vacuum pressure applied to the cartridges.

The connector for operatively allowing fluid communication between the vacuum chamber and the ink cartridge may comprise a coupling on the cartridge holder and a conduit leading from the coupling to the vacuum chamber.

Typically, the connector includes a sealing member for providing a seal adjacent a nozzle of the cartridge.

In a preferred arrangement, at least some of the components of the device are automatically controlled by a PLC or by pneumatic switches, pneumatic control valves and pneumatic timers.

### BRIEF DESCRIPTION OF THE DRAWINGS

The invention will now be described in more detail, by way of example only, with reference to the accompanying drawing in which:

FIG. 1 illustrates a perspective view of a device for cleaning ink cartridges according to one embodiment of the present invention in a raised condition;

FIG. 2 illustrates a cross-sectional view along the line 2-2 in FIG. 1;

FIG. 3 illustrates a cross-sectional view similar to that of FIG. 2 with a needle holder of the device in a first lowered condition; and

FIG. 4 illustrates a cross-sectional view similar to that of FIG. 3 with the needle holder in a second lowered condition.

### DETAILED DESCRIPTION OF THF INVENTION

The invention has application in the field of ink cartridges, and more specifically ink cartridges for printers. The invention is embodied in a device for cleaning ink cartridges such as laser or ink-jet cartridges for printers, and typically finds application in the cleaning of ink cartridges which are to be refilled or remanufactured for subsequent use.

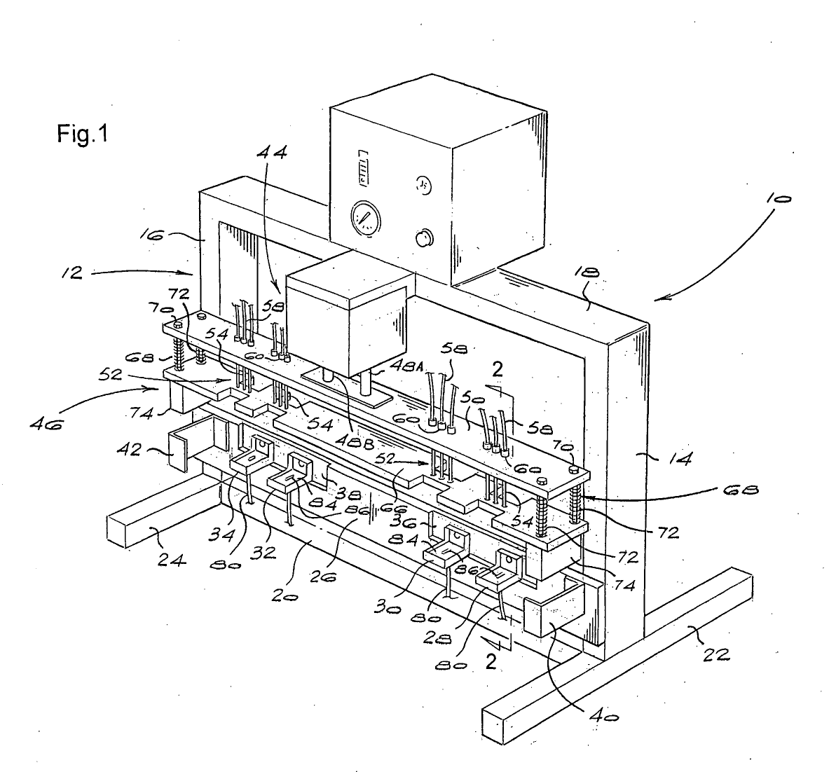

FIG. 1 of the drawings illustrates a device 10 according to one embodiment of the present invention. In this embodiment, the device 10 has a frame 12 which includes a pair of end posts 14 and 16, an upper cross beam 18, a lower cross beam 20 and a pair of feet 22 and 24. The frame components may be formed from steel or aluminium.

A cartridge holding beam 26 may be fixed to the end posts 14 and 16 so as to extend between the posts, as shown. In the illustrated embodiment, the beam 26 is seen to carry four cartridge holders 28, 30, 32 and 34 within two recesses 36 and 38, and a pair of mechanical stops in the form of channel members 40 and 42.

A pneumatic cylinder and ram arrangement 44 may be suspended from the upper cross beam 18, as shown, and a movable needle holder 46 may be connected to the cylinder and ram arrangement 44 at lower ends of a pair of rams 48A and 48B. In the illustrated embodiment, the pneumatic cylinder and ram arrangement 44 may have a relatively long stroke, for example about 100 mm, to accommodate ink cartridges of various different types and sizes. The needle holder 46 may include an upper steel plate 50 which carries four sets of needles 52. As representatively illustrated in the drawings, each set 52 comprises three hollow needles 54 which are mounted to the lower side of the upper plate 50 with luer adaptors 56. On the upper side of the plate 50, conduits 58 and couplings 60 mounted in threaded apertures 62 provide fluid communication between a water tank (not shown) and the needles 54. A control valve (also not shown), such as a solenoid valve, may be used to control the flow of water from the water tank to the needles 54.

The needle holder 46 also includes a lower steel plate 66 which is connected to the upper steel plate 50 with four spring-loaded guide bolts 68. The guide bolts may be formed from stainless steel and may each include a head 70 above the upper plate 50, and a threaded shaft (not visible) which extends through apertures in the upper plate 50, is threaded into threaded apertures (also not visible) in the lower plate 66, and is surrounded by a compression coil spring 72 which may be formed from stainless steel. The coil springs 72 bias the upper plate 50 away from the lower plate 66, and allow relative movement of the upper and lower plates towards one another under a minimum predetermined load.

At each end of the lower plate 66, a guide block 74 may be provided. Each guide block may extend downwardly, as shown, and may be arranged to slide into a channel defined by one of the mechanical stops 40 and 42 when the needle holder 46 is lowered. As representatively illustrated in FIG. 1, the lower plate 66 defines three needle guide holes 76 for each set of needles 54.

If desired, the needle holder 46 may be interchangeable with other similar needle holders to accommodate different ranges of ink cartridges requiring different configurations of the needles 54. In some versions of the needle holder, the lower plate may include slots which extend between the guide holes of each set of needle guide holes for venting excess water from the cartridges and preventing undesirable back pressures on the water flow.

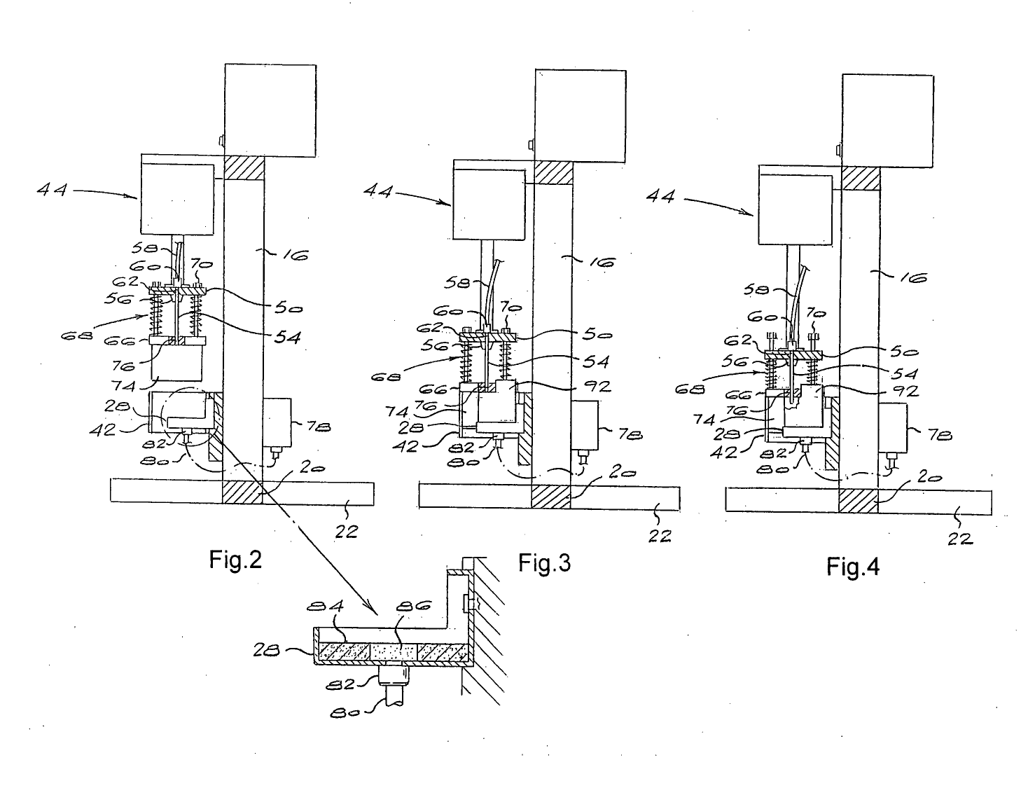

A pair of vacuum pumps 78 (only one of which is visible in FIGS. 2 to 4 of the drawings) may be connected to the cartridge holders 28, 30, 32 and 34 by conduits 80 and couplings 82. With specific reference to FIGS. 2 to 4 of the drawings, each cartridge holder may include a resilient seal member 84 which is located within the holder and which includes a slot 86 for receiving a nozzle on an ink cartridge 92. The seal members 84 may be formed from a silicon rubber, and may each be arranged to locate above an opening 88 in the cartridge holder. The vacuum pumps 78 may be any suitable vacuum pumps, for example Air-Vac Generators of the TD.101L type available from Air-Vac Engineering Company of 30 Progress Avenue, Seymour, Conn. 06483, United States of America. The device 10 may also include a control valve (not shown), such as a solenoid valve, for controlling the vacuum pressure applied to the cartridges 92.

To protect users from moving components on the device 10, a protective cover (not shown), for example a Perspex cover fixed to the needle holder 46, may be provided.

In practice, ink cartridges 92 to be cleaned are inserted into the cartridge holders 28, 30, 32 and 34. Each cartridge holder may include one or more clipping formations for holding the cartridges 92 firmly in place within the cartridge holder. With the ink cartridges properly located within the cartridge holders, the cylinder and ram arrangement 44 is actuated to extend the rams 48A and 48B. As the rams extend, the needle holder 46 is lowered to a first position in which the lower plate 66 engages the mechanical stops 40 and 42, as illustrated in FIG. 3. In this condition, the guide blocks 74 are located within the mechanical stops 40 and 42 and the needles 54 are located directly above the ink cartridges 92. The needles 54 may be positioned so as to align with ink filling apertures in the cartridges 92. In a second phase of the lowering of the needle holder 46, the upper plate 50 is displaced by the rams 48A and 48B towards the lower plate 66 against the bias of the spring-loaded guide bolts 68. In this second phase, the needles 54 are lowered into the ink cartridges 92 through the ink filling apertures until the upper plate 50 engages further mechanical stops (not illustrated) and a pneumatic end switch (also not illustrated). In this condition of the needle holder 46, the needles 54 are properly positioned inside the ink cartridges 92, as illustrated in FIG. 4, and the end switch commences a cleaning cycle.

In the cleaning cycle, the vacuum pumps 78 are actuated to generate a vacuum pressure within a vacuum chamber (not visible), the vacuum control valve is actuated to control the vacuum pressure applied to the cartridges 92, and the water control valve is actuated to allow water to gravity feed from the water tank into the ink cartridges. The water feeding into the cartridges 92 is then sucked or drawn out of the cartridges, through the cartridge nozzles, by the vacuum pressure. In the illustrated embodiment, the vacuum control valve is arranged to apply a vacuum pressure to the cartridges of between 10 inches Hg (34 kPa) and 15 inches Hg (51 kPa). The combined effect of gravity and the suction created by the vacuum pressure forcibly draws the water through the cartridges and removes residual ink in the cartridges in an effective and efficient manner.

Once the cartridges 92 have been cleaned, the water control valve is closed to prevent further flow of water to the needles 54, the vacuum control valve is closed to release the vacuum pressure applied to the cartridges, and the needle holder 46 is returned to its raised position by retraction of the rams 48A and 48B. As the needle holder 46 is raised away from the ink cartridges 92, the upper plate 50 draws the needles 54 out of the ink cartridges, and once the upper plate 50 engages the heads of the spring-loaded guide bolts 68, the upper plate 50 and the lower plate 66 are raised together away from the cartridges 92 into the position illustrated in FIGS. 1 and 2. With the needle holder 46 in the raised condition, the ink cartridges 92 may be removed from the cartridge holders 28, 30, 32 and 34 for refilling or remanufacture.

Preferably, at least a portion of the cleaning process is controlled automatically by a programmable logic controller (PLC). For example, the device 10 may include a pneumatic start switch (not shown) which, when actuated, automatically causes pneumatic actuation of the pneumatic cylinder and ram arrangement 44 to effect extension of the rams 48A and 48B. As the rams extend, the needle holder 46 is displaced downwardly into the lowered condition illustrated in FIG. 4 in which the upper plate 50 engages and actuates the pneumatic end switch. Upon actuation of the pneumatic end switch, the PLC may be arranged to automatically actuate the vacuum pump, and to control the operation of the vacuum control valve and the water control valve so as to effect desired cleaning of the ink cartridges for a predetermined time. Upon lapsing of the predetermined time, the PLC may be arranged to close the vacuum control valve and the water control valve so as to automatically prevent further cleaning of the cartridges, and to actuate the pneumatic cylinder and ram arrangement 44 so as to withdraw the rams 48A and 48B, and hence the needle holder 46, from the cartridges 92, thereby allowing the cartridges to be removed for subsequent refilling or remanufacture.

In another embodiment, instead of the PLC and the solenoid control valves, the operation of the device may be controlled automatically by pneumatic control valves and a pneumatic timer.

It will be appreciated that by allowing the water to gravity feed into the cartridges and by simultaneously applying a vacuum pressure to the cartridges, the device of the invention forcible draws the water through the cartridges and their nozzles to remove residual ink from the cartridges in an effective and efficient manner.

We claim:

1. A method for cleaning an ink cartridge, the method including the steps of:
introducing a cleaning fluid into an ink cartridge to be cleaned; and
drawing the cleaning fluid out of the ink cartridge through a nozzle of the cartridge by vacuum pressure.

2. A method according to claim 1, wherein the cleaning fluid is water and the method includes the step of introducing the water into the ink cartridge through one or more needles.

3. A method according to claim 2, wherein the water is allowed to gravity feed into the ink cartridge through a plurality of needles.

4. A method according to claim 3, including the step of inserting the needles into the ink cartridge through ink filling apertures in the cartridge.

5. A method according to claim 1, wherein the flow of cleaning fluid into the ink cartridge is controlled by at least one valve.

6. A method according to claim 1, wherein the step of drawing the cleaning fluid out of the ink cartridge may include the steps of:
forming a vacuum in a vacuum chamber; and
providing fluid communication between the ink cartridge and the vacuum chamber so as to apply vacuum pressure to the ink cartridge.

7. A method according to claim 6, including the step of controlling the vacuum pressure applied to the ink cartridge.

8. A method according to claim 7, wherein the vacuum pressure applied to the ink cartridge is maintained between 10 inches Hg (34 kPa) and 15 inches Hg (51 kPa).

9. A method according to claim 1, including the step of cleaning a plurality of ink cartridges simultaneously.

10. A method according to claim 1, wherein at least some of the method steps are carried out automatically by means of a programmable logic controller (PLC), or by using pneumatic switches, pneumatic control valves and pneumatic timers.

11. A device for cleaning an ink cartridge, the device including:
a mechanism for introducing a cleaning fluid into an ink cartridge to be cleaned;
a vacuum chamber;
means for forming a vacuum pressure within the vacuum chamber; and
a connector for operatively allowing fluid communication between the vacuum chamber and the ink cartridge for drawing the cleaning fluid out of the cartridge through a nozzle of the cartridge by vacuum pressure.

12. A device according to claim 11, wherein the mechanism for introducing the cleaning fluid into the ink cartridge comprises one or more needles mounted to a needle holder.

13. A device according to claim 12, wherein the needles are connectable to a water tank.

14. A device according to claim 13, including at least one valve for controlling the flow of water from the water tank into the ink cartridge.

15. A device according to claim 11, including a cartridge holder for holding one or more ink cartridges.

16. A device according to claim 12, wherein the needle holder is movable between a first position in which the needles are withdrawn from one or more ink cartridges, and a second position in which the needles are inserted into the one or more ink cartridges.

17. A device according to claim 11, wherein the means for forming a vacuum pressure within the vacuum chamber comprises a vacuum pump, and the device includes at least one valve for controlling the vacuum pressure applied to the cartridges.

18. A device according to claim 15, wherein the connector for operatively allowing fluid communication between the vacuum chamber and the ink cartridge comprises a coupling on the cartridge holder and a conduit leading from the coupling to the vacuum chamber.

19. A device according to claim 18, wherein the connector includes a sealing member for providing a seal adjacent a nozzle of the cartridge.

20. A device according to claim 11, wherein at least some of the components of the device are automatically controlled by a programmable logic controller (PLC), or by pneumatic switches, pneumatic control valves and pneumatic timers.
